(19) United States
(12) Patent Application Publication
(10) Pub. No.: US 2007/0182255 A1
(43) Pub. Date: Aug. 9, 2007

(54) Safety switching module

(76) Inventors: Martin Dietmar Klaus Schneiderheinze, Perth (AU); Dirk Henrik Paul Schneiderheinze, Perth (AU)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 10/599,480

(22) PCT Filed: Mar. 31, 2005
(86) PCT No.: PCT/AU05/00458

§ 371 Date: Sep. 29, 2006

(30) Foreign Application Priority Data
Apr. 1, 2004 (AU) 2004901729

(51) Int. Cl. H01H 47/00

(52) U.S. Cl. 307/125

(57) ABSTRACT

A safety switching module (10) including at least two switch units connected in series and a switch control unit (20) for each switch unit (18). Each switch control unit (20) has a switch control input (38,40) to receive a shut down to open the respective switch unit (18). A switch monitoring means (46) is provided for each switch unit (18) to monitor whether the respective switch unit (18) is open or closed and is connected to the respective switch control unit (20) such that the switch control unit (20) can determine that a fault condition exists if the respective switch unit (18) has not opened on receiving the shut down signal. An operation control input (60) is provided on at least one of the switch control units (20) connectable to an operation controller (62) for controlling operation of the load. Each of the switch control units (20) is in communication with each other switch control units (20) to determine if fault conditions exist in any of the switch units (18). The switch control unit (20) connected to the operation controller (62) is arranged to open and close the respective switch unit (18) in response to signals received from the operation controller (62) unless any of the switch control units (20) have a fault condition or a have received the shut down

### FIELD OF THE INVENTION

The present invention relates to a safety switching module for controlling power flow to electrical equipment.

### BACKGROUND OF THE INVENTION

The use of safety switching modules is known in industrial applications where the means for controlling activation of a piece of machinery is deemed not be of a sufficient standard of safety. Where a control means, such as an activation switch, is provided between the main power supply and a load such as a piece of industrial machinery, the control means often does not have suitably high fault tolerance or duplicated components which would ensure that the mains power can be disconnected from the load with sufficient reliability.

In many cases, the machinery under control may have moving parts which can pose a safety hazard to the operators. It is therefore necessary to ensure that the disconnection of the mains power from the load in emergency situations, is sufficiently reliable. It is therefore common to provide a safety switching module in the current path between the mains power and the load. The safety switching module is controlled by an appropriate means, which may be for example, an emergency shut off switch.

A known arrangement for a safety switching module is the use of a module including electromechanical safety relays. In this arrangement, duplicated electromechanical relays having positively guided contacts are provided in series in the current path between the mains power supply and the load. The emergency switch includes dual contacts which, on activation of the emergency switch, de-energise respective relays, thereby breaking the connection between load and power supply. Should either of the contacts or respective relays fail to open, the other will still ensure the disconnection of the load. It is assumed that the probability of both failing independently is negligible.

Such safety switching modules have been provided in the past in the form of modules comprising only electromechanical safety relays to control the safety switching. Later versions of the safety modules have been implemented which include electromechanical relays in the current path between the load and the power supply but utilise standard electronic components to implement the logic functions required to control the relays based on inputs from the emergency switch. The logic functions are implemented in duplicated logic units inside a switching control module. The previous safety switching modules also include a means to detect faults, such as one of the relays not opening. In general the safety switching modules are provided with two monitoring contacts which are connected to the relays in the current path such that the monitoring contacts close when the relays in the current path open. These monitoring contacts are included in series in the path of a reset circuit such that if either one of the monitoring contacts stays open, that is the corresponding relay remained closed (e.g. due to contact welding), then reset of the safety switching module could not occur. While this method is adequate for detecting faults, it does not allow detection of which component is faulty.

The present invention relates to a safety switching module providing improved functionality with respect to prior art safety switching modules.

### SUMMARY OF THE INVENTION

In accordance with one aspect of the present invention there is provided a safety switching module characterised by comprising:

at least two switch control units each having a switch control input to receive a shut down signal and an output connected to a respective switch unit of a plurality of series connected switch units, such that the switch control unit opens the respective switch unit on receiving the shut down signal;

a switch monitoring means provided for each switch control unit, each switch monitoring means being arranged to monitor whether the respective switch unit is open or closed and thereby determine that a fault condition exists if the respective switch unit has not opened on receiving the shut down signal; and

an operation control input on at least one of the switch control units, the operation control input being connectable to an operation controller for controlling operation of the load;

wherein each of the switch control units is in communication with each other switch control unit such that each switch control unit can determine if fault conditions exist in any of the switch units and the or each switch control unit connected to the operation controller being arranged to open and close the respective switch unit in response to signals received from the operation controller unless any of the switch control units have a fault condition or a have received the shut down signal.

### BRIEF DESCRIPTION OF THE DRAWINGS

The present invention will now be described, by way of example, with reference to the accompanying drawings, in which:

FIG. 1 is a schematic view of a safety switching module in accordance with the present invention.

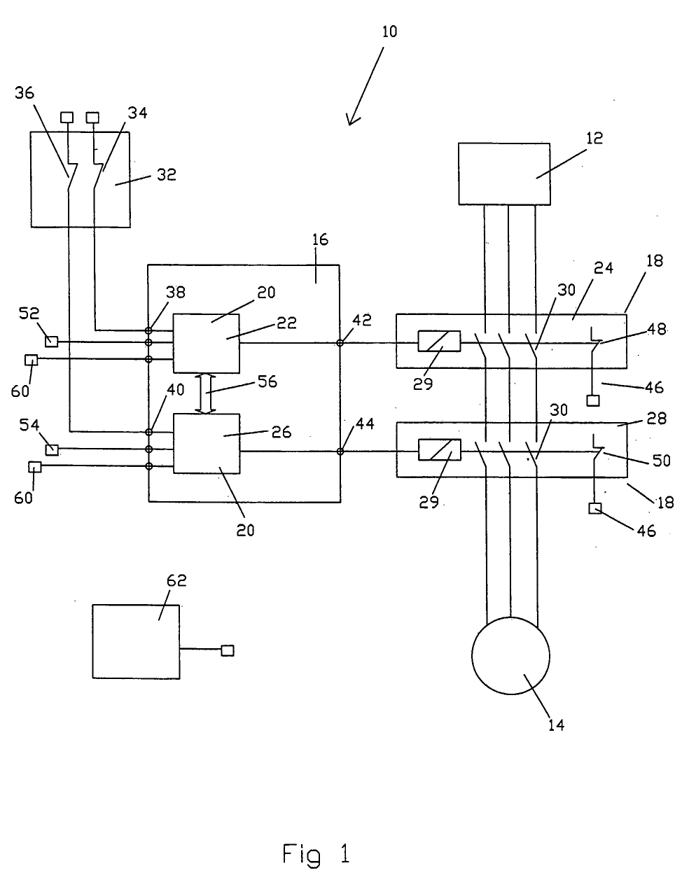

### DESCRIPTION OF THE INVENTION

Referring to the Figures, there is shown a safety switching module 10 for providing safety switching between a mains power supply 12 and a load 14. The safety switching module 10 comprises a switching control module 16 connectable to a plurality of switch units 18. The switching control module 16 includes a plurality of switch control units 20, where each switch control unit 20 is arranged to control a respective switching unit 18.

In the embodiment shown in the Figure, there is provided a first switch control unit 22 to control the switching of a first switch unit 24 and a second switch control unit 26 to control the switching of a second switch unit 28. Each of the switch units 24 and 28 comprise a control solenoid 29 controlling three contacts 30 in the path of current flow from the power supply 12 to the three phase load 14.

The safety switching module 10 is arranged to disconnect the load 14 from the power supply 12 in response to a shut down switch 32. The shut down switch 32 includes first and second contacts 34 and 36. The first contact 34 is connected to a first switch control input 38 on the first switch control unit 22 and the second contact 36 is connected to a second switch control input 40 on the second switch control unit 26. The first and second switch control units 22 and 26 are provided in the form of suitable electronic components having the ability to provide the necessary logic functions for control of the switch units 24 and 28. The first and second switch control units 22 and 26 are arranged such that on receiving a shut down signal (in this case the opening of the contacts 34 and 36 in the shut down switch 32), the switch control units 22 and 26 generate a signal on respective outputs 42 and 44 which are connected to the control solenoids 29 to open the contacts 30. That is, the first switch control unit 22 is arranged to open the first switch unit 24 on receiving a shut down signal on the first switch control input 38 and the second switch control unit 26 is arranged to open the second switch unit 28 on receiving a shut down signal on the second switch control input 40.

The first and second switch units 24 and 28 are provided with respective monitoring means 46 in the form of first and second monitoring contacts 48 and 50. The monitoring means are provided to monitor whether the contacts 30 are open or closed. The monitoring contacts 48 and 50 are connected to the respective contacts 30 of the first and second switch units 24 and 28 such that movement of the contacts 30 causes movement of the first and second monitoring contacts 48 and 50.

The first monitoring contact 48 is connected to a first monitoring input 52 on the first switch control unit 22. The second monitoring contact 50 is connected to a second monitoring input 54 on the second switch control unit 26. Each of the first and second switch control units 22 and 26 are arranged such that they can compare the status of the respective first or second monitoring inputs 52 or 54 with the status of the respective first or second switch control inputs 38 or 40 to determine if a fault condition exists. That is, if the switch control unit 22 or 26 has initiated the opening of the respective switch unit 24 or 28 and the monitoring input 52 or 54 indicates that the switch unit 24 or 28 has not actually opened, then a fault condition is determined.

The first and second switch control units 22 and 26 are arranged to communicate information regarding their current state to each other. The information communicated includes whether a fault condition has been detected. The information may also include whether a shut down signal has been received. The communication of information between the first and second switch control units 22 and 26 is via a communication bus 56 connecting each of the switch control units 22 and 26.

While the embodiment shown in the drawings is arranged such that the first monitoring contact 48 is connected to the first switch control unit 22 and the second monitoring contact 50 is connected to the second switch control unit 26, it would also be possible to employ a reciprocal monitoring arrangement. That is, the first monitoring contact 48 being connected to the second switch control unit 26 and the second monitoring contact 50 being connected to the first switch control unit 22. Each of the first and second switch control units 22 and 26 is also provided with an operation control input 60. The operation control inputs 60 are connected to an operation controller 62. The operation controller 62 comprises any device provided for controlling the operation of the load 14, for example a simple on/off switch. The first and second switch control units 22 and 26 are set up such that they will control the opening and closing of the first and second switch units 24 and 28 based on the input on operation control inputs 60, as long as no fault condition has been detected and no shut down signals are received by the switching control module 16.

That is, safety switching module 10 performs the function of an operation controller, which would otherwise be provided as a separate apparatus controlling its own switch in the current path between the power supply 12 and the load 14. This is made possible without compromising the safety functions of the safety switching module 10 by the arrangement of the separate monitoring means 46 and communication between the switch control units 22 and 26.

The safety switching module 10 may also be provided with a bus interface (not shown). The bus interface may be used to connect a plurality of safety switching modules together such that information may be exchanged between the switch control units of different safety switching modules. The information exchanged may include the status of monitoring contacts, operation control inputs, switch control inputs or any other desired information (e.g. self test information or device on status)

While in the embodiment shown in the Figures, the operation controller 62 has a single output (on/off) which is connected to one or more of the switch control units 20, an operation controller 62 which uses multiple outputs may also be used. For example, two hand control switches are known, where an operator has to activate each switch with a separate hand within a predetermined time period to start the machinery. In this case, the first switch of the two hand control is connected to the operation control input 60 on the first switch control unit 22 and the second switch of the two hand control is connected to the operation control input 60 on the second switch control unit 26. The first and second switch control units 22 and 26 can communicate with each other and control operation if the two hand control switch is activated correctly (i.e. both switches activated with the predetermined time period).

The integration of the safety switching functions and operation control functions as described above has significant advantages. For example, in the case of a separate safety switching module, the switches are generally inactive in a closed state for extended periods of time which results in increased potential for the contacts failing to open when required, due to build up of dust or corrosion. The use of the safety switching module switches for operational function increases the use of the switches and therefore decreases the likelihood of this occurring. Also, as these switches are used more regularly, it provides more opportunities to verify the correct functioning of the switches. Further, since operational switching (as opposed to safety switching) requires the use of one switch unit only at each instance, the first and second switch control units 22 and 26 may be arranged such that the first and second switch units 24 and 28 are operated alternately, so that utilisation extends over nearly twice the service life of that of one switch unit.

The integration also provides an economic advantage in that the purchase of a separate operation control switch is no longer required. Another economic advantage results from an alternating use of the switch units for control switching.

While the present invention has been described in an application in which the safety switching is provided for a three phase power application, it will be appreciated that other applications, including switching of non-electrical connections would also be possible. For example, the safety switching module may be used to control operation of valves in a fluid line instead of contacts in an electrical connection.

Modifications and variations as would be apparent to a skilled addressee are deemed to be within the scope of the present invention

1. A safety switching module characterised by comprising:
at least two switch control units each having a switch control input to receive a shut down signal and an output connected to a respective switch unit of a plurality of series connected switch units, such that the switch control unit opens the respective switch unit on receiving the shut down signal;
a switch monitoring means provided for each switch control unit, each switch monitoring means being arranged to monitor whether the respective switch unit is open or closed and thereby determine that a fault condition exists if the respective switch unit has not opened on receiving the shut down signal; and
an operation control input on at least one of the switch control units, the operation control input being connectable to an operation controller for controlling operation of the load;
wherein each of the switch control units is in communication with each other switch control unit such that each switch control unit can determine if fault conditions exist in any of the switch units and the or each switch control unit connected to the operation controller being arranged to open and close the respective switch unit in response to signals received from the operation controller unless any of the switch control units have a fault condition or a have received the shut down signal.

2. A safety switching module in accordance with claim 1, characterised in that the switch monitoring means comprises a monitoring input provided on each switch control unit, each monitoring input being connectable to a monitoring contact provided on the respective switch unit.

3. A safety switching module in accordance with claim 2, characterised in that the switch units each comprise a solenoid having the monitoring contact physically connected to the solenoid contacts.

4. A safety switching module in accordance with any one of the preceding claims, characterised in that the shutdown signal is generated by a shutdown switch having a plurality of contacts, each of the shut down switch contacts being connected to a switch control input of a respective switch control unit.

5. A safety switching module in accordance with any one of the preceding claims, characterised in that each of the switch control units comprise a processor, the processors being interconnected by a bus for the transfer of information, said information including whether any of the switch control units have detected a fault condition.

6. A safety switching module in accordance with any one of the preceding claims, characterised in that each of the switch control units communicates with the other switch control units to allow control of alternating switch units in response to operation control signals received on said switch control unit.

7. A safety switching module in accordance with any one of the preceding claims characterised in that an operation controller having multiple outputs is connected to the operation control inputs on multiple switch control units and the switch control units exchange information to determine if a control signal has been received on each of said operation control inputs and only control operation of the respective switch units if operation control inputs have been received on each of said operation control inputs.

8. A safety switching module in accordance with any of the preceding claims, characterised in that the safety switching module is provided with a bus interface for exchange of information between other safety switching modules.
